(19) United States
(12) Patent Application Publication
(10) Pub. No.: US 2020/0301192 A1
(43) Pub. Date: Sep. 24, 2020

(54) FLEXIBLE LIQUID CRYSTAL DISPLAY DEVICE

(71) Applicant: InnoLux Corporation, Miao-Li County (TW)

(72) Inventors: Hsin-Hao Huang, Miao-Li County (TW); Chu-Hong Lai, Miao-Li County (TW)

(21) Appl. No.: 16/799,808

(22) Filed: Feb. 24, 2020

(30) Foreign Application Priority Data
Mar. 20, 2019 (CN) 201910213457.3

(51) Int. Cl. G02F 1/1333

(52) U.S. Cl. CPC G02F 1/133305; G02F 2001/133331; G02F 2202/28; G02F 1/133308

(57) ABSTRACT

A flexible liquid crystal display device includes a first flexible substrate, a second flexible substrate, a liquid crystal layer, a cover layer and a waterproof glue. The second flexible substrate is disposed opposite to the first flexible substrate, and the liquid crystal layer is disposed between the first flexible substrate and the second flexible substrate. The cover layer covers the second flexible substrate and has a surface facing the second flexible substrate. The waterproof glue is adhered to the surface of the cover layer and a side of the second flexible substrate.

### BACKGROUND OF THE DISCLOSURE

### 1. Field of the Disclosure

The present disclosure relates to a liquid crystal display device, and more particularly to a flexible liquid crystal display device.

### 2. Description of the Prior Art

A flexible electronic device is a novel technology of manufacturing electronic components and elements on foldable (or bendable, stretchable or flexible) substrates. In comparison with a rigid electronic device, the flexible electronic device provides many advantages including small size, cost effectiveness, light weight, durability, flexibility and portability. This technology becomes more and more popular because of the potential uses in electronic applications, including flexible displays, flexible touch panels, wearable electronic devices, etc.

Currently, extensive studies have been conducted on the research and development of flexible displays. However, even so, there are still many technical defects to be overcome. For example, for the flexible displays, especially for flexible liquid crystal displays, after using a certain period of time, the side of the flexible substrate (such as a color filter substrate and/or a thin film transistor substrate) in the display may be peeled off from the cover layer (such as a glass cover). This defect not only may cause abnormal displaying images at the peripheral portion of the flexible display, but also may cause the flexible display to occur a large area of the abnormal displayed images because the irruption of external matters from the peeling regions, which reduces the reliability or lifetime of the flexible display.

### SUMMARY OF THE DISCLOSURE

Accordingly, it is necessary to provide an improved flexible liquid crystal display device to solve the problems encountered by current flexible liquid crystal display devices.

According to an embodiment, the present disclosure provides a flexible liquid crystal display device including a first flexible substrate, a second flexible substrate, a liquid crystal layer, a cover layer and a waterproof glue. The second flexible substrate is disposed opposite to the first flexible substrate, and the liquid crystal layer is disposed between the first flexible substrate and the second flexible substrate. The cover layer has a surface facing the second flexible substrate, and the waterproof glue is adhered to the surface of the cover layer and a side of the second flexible substrate.

According to the flexible liquid crystal display device of this embodiment in the present disclosure, since the waterproof glue is adhered to the surface of the cover layer and the side of the second flexible substrate, the probability of the second flexible substrate, especially the side thereof, peeling off from the surface of the cover layer may be reduced, and thus the reliability or lifetime of the flexible liquid crystal display device may be increased.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a top view schematic diagram of a flexible liquid crystal display device according to a first embodiment of the present disclosure.

FIG. 2 is a cross-sectional view schematic diagram of a flexible liquid crystal display device according to a first embodiment of the present disclosure.

FIG. 3 is a cross-sectional view schematic diagram of a flexible liquid crystal display device according to a second embodiment of the present disclosure.

FIG. 4 is a cross-sectional view schematic diagram of a flexible liquid crystal display device according to a third embodiment of the present disclosure.

FIG. 5 is a top view schematic diagram of a flexible liquid crystal display device according to a fourth embodiment of the present disclosure.

FIG. 6 is a top view schematic diagram of a flexible liquid crystal display device according to a fifth embodiment of the present disclosure.

FIG. 7 is a cross-sectional view schematic diagram of a flexible liquid crystal display device according to an embodiment of the present disclosure.

### DETAILED DESCRIPTION

The present disclosure may be understood by reference to the following detailed description, taken in conjunction with the drawings as described below. It is noted that, for purposes of conciseness of the drawings and being easily understood by one skilled in the art, the components in the drawings may not be drawn to practical scale. In addition, the number and dimension of each component shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function. The terms “include”, “comprise” and/or “have” used in the description of the present disclosure are open-ended terms, so it should be interpreted as the meaning of “including but not limited to . . . .”

When a component or a layer is referred to “disposed on another component or another layer” or “connected to another component or another layer”, it may represent that the component or the layer is directly disposed on another component or layer or directly connected to another component or layer, or other intermediate component or layer may exist between them. By comparison, when a component is referred to “directly disposed on another component or layer” or “directly connected to another component or another layer”, any intermediate component or layer does not exist between them.

The term “face” mentioned in the present disclosure refers to a component being close to another component, and the term “face away from” refers to a component being away from another component. The term “flexible device” means that the device can be bent, folded, curled, flexed or other similarly actuated along at least one bending axis, but not limited thereto. According to some embodiments, the device may also be respectively bent along more than two bending axes.

It should be noted that the technical features in different embodiments described in the following description can be replaced, recombined or mixed with one another to constitute another embodiment without departing from the spirit of the present disclosure.

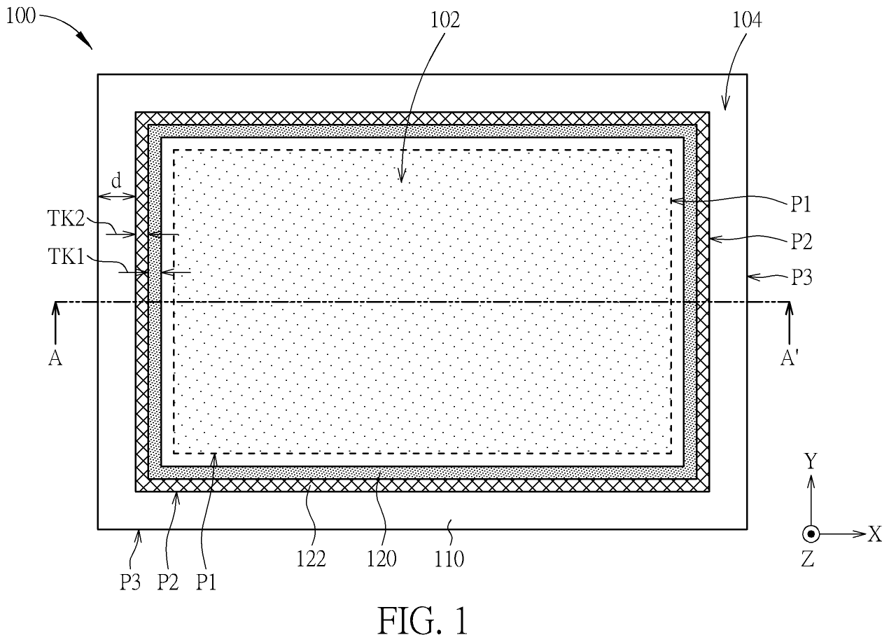

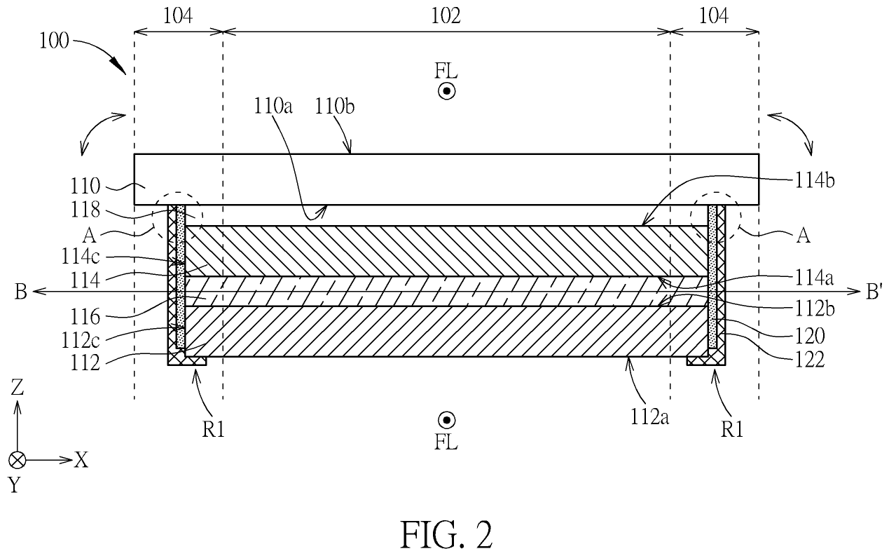

Please refer to FIG. 1 and FIG. 2. FIG. 1 is a top-view schematic diagram of a flexible liquid crystal display device according to a first embodiment of the present disclosure. FIG. 2 is a cross-sectional view schematic diagram of a flexible liquid crystal display device according to a first embodiment of the present disclosure. The flexible liquid crystal display device 100 includes a cover layer 110, a waterproof glue 120 and an adhesive material 122, and the adhesive material 122 may surround the waterproof glue 120. The flexible liquid crystal display device 100 may be divided into a display region 102 and a peripheral region 104. The display region 102 refers to a region where the display device presents images, and the peripheral region 104 refers to a region that does not present images or refers to a region for accommodating peripheral circuits. The waterproof glue 120 and the adhesive material 122 may be respectively disposed along an edge P1 of the display region 102 to make the waterproof glue 120 and the adhesive material 122 surround the display region 102. For not affecting the presentation of the images, the waterproof glue 120 and the adhesive material 122 may not be disposed in the display region 102, and may be just disposed in the peripheral region 104. The waterproof glue 120 has a width TK1, and the adhesive material 122 has a width TK2 (which are measured along the same direction such as the direction X, or a horizontal direction of the cover layer 100). The width TK1 and the width TK2 can be identical, or can be different, but not limited thereto. In this embodiment, the width TK1 and the width TK2 are both 2 mm. Besides, in a top view, the waterproof glue 120 may be disposed between the edge P1 of the display region 102 and an edge P2 of the adhesive material 122 which is away from the display region 102, and the waterproof glue 120 is close to the display region 102, and the protection effect is increased. A distance d between the edge P2 of the adhesive material 122 and an edge P3 of the cover layer 110 can be reserved according to the design requirement. In this embodiment, the distance d may be 1.5 cm to 3 mm, but not limited thereto. In other embodiment, the edge P2 of the adhesive material 122 may also be aligned with the edge P3 of the cover layer 110. In order to describe the present disclosure more clearly, the structure of the device shown in FIG. 1 is described in the following. Please noted that FIG. 1 is a top view of the flexible liquid crystal display device 100 through the liquid crystal layer, and is a top view through the section plane BB′ of the liquid crystal layer 116 in FIG. 2 for example.

FIG. 2 is a cross-sectional view schematic diagram of a flexible liquid crystal display device according to a first embodiment of the present disclosure, which can be a flexible liquid crystal display device that is drawn along the section line A-A′ of FIG. 1. The flexible liquid crystal display device 100 further includes a first flexible substrate 112, a second flexible substrate 114 and a liquid crystal layer 116. Wherein, the second flexible substrate 114 is disposed opposite to the first flexible substrate 112, and the liquid crystal layer 116 is disposed between the first flexible substrate 112 and the second flexible substrate 114. The cover layer 110 is disposed on the second flexible substrate 114, and the cover layer 110 has a first surface 110b facing away from the second flexible substrate 114 and a second surface 110a facing the second flexible substrate 114. The first flexible substrate 112 may include a first surface 112b and a second surface 112a opposite to each other, and the first surface 112b faces the second flexible substrate 114. The second flexible substrate 114 may include a first surface 114b and a second surface 114a opposite to each other, and the first surface 114b faces the cover layer 110, while the second surface 114a faces the first flexible substrate 112.

An optical adhesive 118 is disposed between the second flexible substrate 114 and the cover layer 110, and fixed the second flexible substrate 114 and the cover layer 110. The waterproof glue 120 is adhered to a portion of the second surface 110a of the cover layer 110 and a side 114c of the second flexible substrate 114. In this embodiment, the waterproof glue 120 can be further adhered to a portion of a side 112c of the first flexible substrate 112. The adhesive material 122 is adhered to a portion of the second surface 110a of the cover layer 110 and a portion of the first flexible substrate 112. In this embodiment, the adhesive material 122 is not only adhered to the side 112c of the first flexible substrate 112 and the second surface 112a of the first flexible substrate 112, but also can be directly in contact with the waterproof glue 120. As a result, in addition to strengthening the integral firmness of the flexible liquid crystal display device 100, and the risk of the adhesive material 122 peeling from the first flexible substrate 112 may also be reduced.

According to this embodiment, the waterproof glue 120 is disposed between the adhesive material 122 and the first flexible substrate 112 and disposed between the adhesive material 122 and the second flexible substrate 114, and the waterproof glue 120 can attach to the first flexible substrate 112 and the second flexible substrate 114. According to the test results, disposing the waterproof glue 120, for example, to at least cover the side 114c of the second flexible substrate 114 may reduce the moisture to be absorbed by the edge portion of the second flexible substrate 114. Therefore, it can reduce the chance that the second flexible substrate 114 is peeling off from the cover layer 110. For example, when taking the bending axis FL shown in FIG. 2 as a center and applying force in the directions of the double arrows to flex the first flexible substrate 112 and the second flexible substrate 114, peeling off of the second flexible substrate 114 from the portion marked with the regions A may be reduced. Therefore, the reliability or lifetime of the flexible liquid crystal display device 100 may be enhanced. It is noted that, the number of the folding axis FL can be more than one and is not limited to one, and the location thereof can be arbitrarily defined according to a user's manner. In addition, the directions of the double arrows in the drawing are merely illustrative and are not intended to restrict the practical direction of force application.

The waterproof glue 120 may be materials having waterproof properties, such as silicone gel, polyurethane (PU), polyethylene terephthalate (PET), polycarbonate (PC), polymethyl methacrylate (PMMA), etc. The adhesive material 122 may be materials having higher adhesion such as polymer material having adhesion, and to make the waterproof glue 120 to more closely and firmly attach to the side 114c of the second flexible substrate 114, and reduce the waterproof glue 120 from peeling off from the side 114c of the second flexible substrate 114. The adhesion of the adhesive material 122 described above is the result of comparison with the adhesion of the optical adhesive 118, which means the adhesive material 122 has an adhesion better than the optical adhesive 118. In particular, in addition to fixing the second flexible substrate 114 and the cover layer 110, the optical adhesive 118 also need to have the function of light transmission, and by comparison, the adhesive material 122 is mainly used to strengthen the integral firmness of the flexible liquid crystal display device 100, so it has higher requirement for adhesion. In this embodiment, the waterproof glue 120 is fluid, so it can be coated by a nozzle and then placed stand to make the waterproof glue 120 dry and solidify. The adhesive material 122 is disposed in the form of a sheet. In other embodiments, the adhesive material 122 also can present as fluid glue, and be disposed through a coating method, but not limited thereto. Besides, according to an embodiment of the present disclosure, since the waterproof glue 120 and the adhesive material 122 may be located at the peripheral region 104 of the flexible liquid crystal display device 100 (as shown in FIG. 1 for example) and may not be disposed in the display region 102 of the flexible liquid crystal display device 100, it is not necessary to consider the transmittance of the waterproof glue 120 and the adhesive material 122 when choosing the materials.

In addition, the main body of the cover layer 100 can be a cover glass, a protecting layer or a plastic substrate. The main body of the first flexible substrate 112 and the main body of the second flexible substrate 114 can be a plastic substrate respectively, and the water absorption rate of the first flexible substrate 112 and the second flexible substrate 114 may be higher than the water absorption rate of the cover layer 110. In regard to the condition that the water absorption rate of the first flexible substrate 112 and the water absorption rate of the second flexible substrate 114 is higher than the water absorption rate of the cover layer 110. The main body of the first flexible substrate 112 and/or the main body of the second flexible substrate 114 can be polyimide resin, polyester resin, polyethersulfone resin, cellulose resin, polyacrylate resin, polystyrene resin, polyolefin resin, polycarbonate resin and polysulfone resin, but not limited thereto. The main body of the cover layer 110 can be glass or the above described resin having lower water absorption rate than the first flexible substrate 112 and/or the second flexible substrate 114. In this embodiment, the polyimide resin is used mainly. It is noted that, the cover layer 110, the first flexible substrate 112 and the second flexible substrate 114 described above are rectangles for example, but not limited thereto, and they can also be presented in any other suitable shapes, such as triangles, rhombuses, trapezoids, wedges, other polygons or irregular shapes with arc edges.

Besides, the liquid crystal material in the liquid crystal layer 116 can be nematic liquid crystal, smectic liquid crystal, cholesteric liquid crystal, etc., but not limited thereto. In addition, the first flexible substrate 112 can include components or layers, such as switch elements (thin film transistors for example), a polarizer, conductive lines, etc. The second flexible substrate 114 can include components or layers, such as a color filter, a polarizer, a light shielding layer, conductive lines, etc., and they are not shown herein for conciseness.

The flexible liquid crystal display device is not limited to the above embodiments, and there may be different variation embodiments. For simplifying the description, the different variation embodiments in the following will use the same reference numerals as the first embodiment to symbol the same elements. In order to easily compare the differences between the first embodiment and the different variation embodiments, the following description will emphasize the differences of the different variation embodiments, and the repeated part will not be described redundantly.

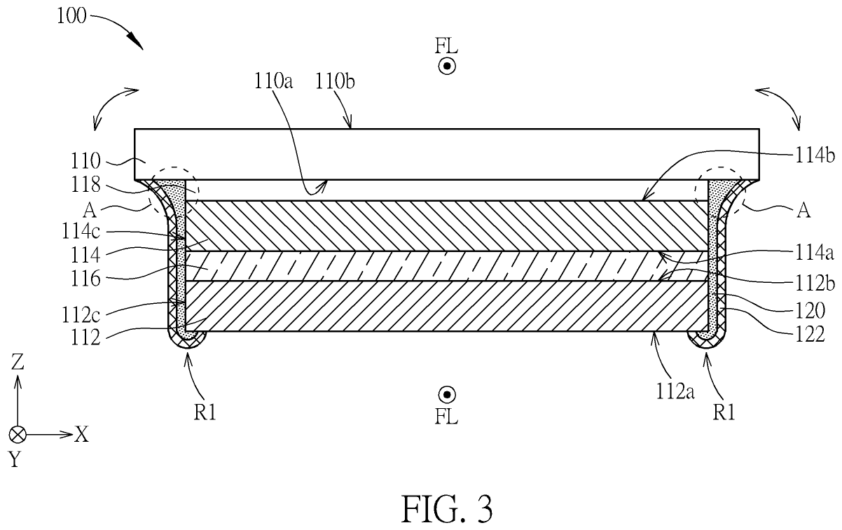

FIG. 3 is a cross-sectional view schematic diagram of a flexible liquid crystal display device according to a second embodiment of the present disclosure. According to this embodiment, the waterproof glue 120 may be further adhered to the second surface 112a of the first flexible substrate 112. By adhering the waterproof glue 120 to the second surface 112a of the first flexible substrate 112, the moisture can be more resisted from entering the flexible liquid crystal display device 100, and therefore the risk of peeling off of the second flexible substrate 114 at the regions A or adjacent the regions A can be reduced. In this embodiment, the portions of the waterproof glue 120 and the adhesive material 122 that are adhered to the second surface 110a of the cover layer 110 have a shape of curved surface. In addition, the portions of the waterproof glue 120 and the adhesive material 122 that are adhered to the second surface 112a of the first flexible substrate 112 (that is, the bottom regions R1) have a shape of curved surface, and in addition to increasing the aesthetic effect of the appearance, it can also reduce the user be wounded when using the device, but the present disclosure is not limited thereto.

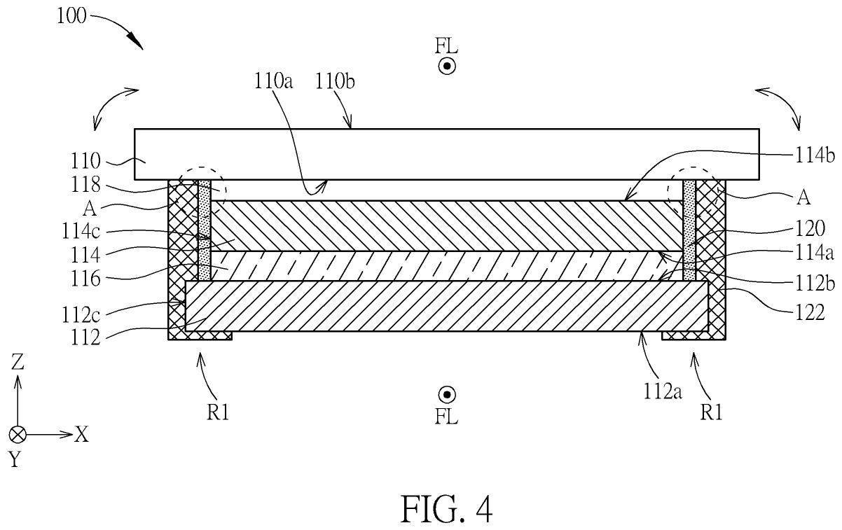

FIG. 4 is a cross-sectional view schematic diagram of a flexible liquid crystal display device according to a third embodiment of the present disclosure. According to this embodiment, the width of the first flexible substrate 112 in the direction X is greater than that of the second flexible substrate 114, but not limited thereto. Furthermore, the waterproof glue 120 is adhered to a portion of the first surface 112b of the first flexible substrate 112, and the adhesive material 122 is adhered to the side 112c of the first flexible substrate 112 and the second surface 112a of the first flexible substrate 112.

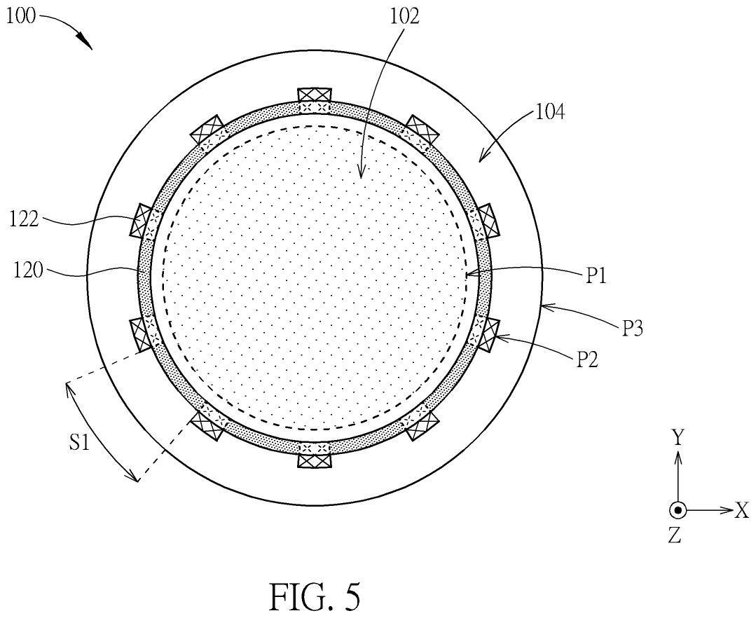

FIG. 5 is a top view schematic diagram of a flexible liquid crystal display device according to a fourth embodiment of the present disclosure. The waterproof glue 120 and the adhesive material 122 are respectively disposed along the edge P1 of the display region 102, and the adhesive material 122 of this embodiment presents as a pattern of interrupted lines in a top view, and a portion of the edge P1 of the display region 102 may not be covered by the adhesive material 122. The interrupted lines can present as an arrangement of dashed lines or dash dotted lines, and there is a space S1 between adjacent segments of the adhesive material 122, but not limited thereto. The spaces S1 can be equal or not equal to each other according to the design, and are not limited. In this embodiment, the waterproof glue 120 is disposed along the edge P1 of the display region 102 and does not has a pattern of interrupted lines, and the resisting ability of the moisture from entering the flexible liquid crystal display device 100 is increased.

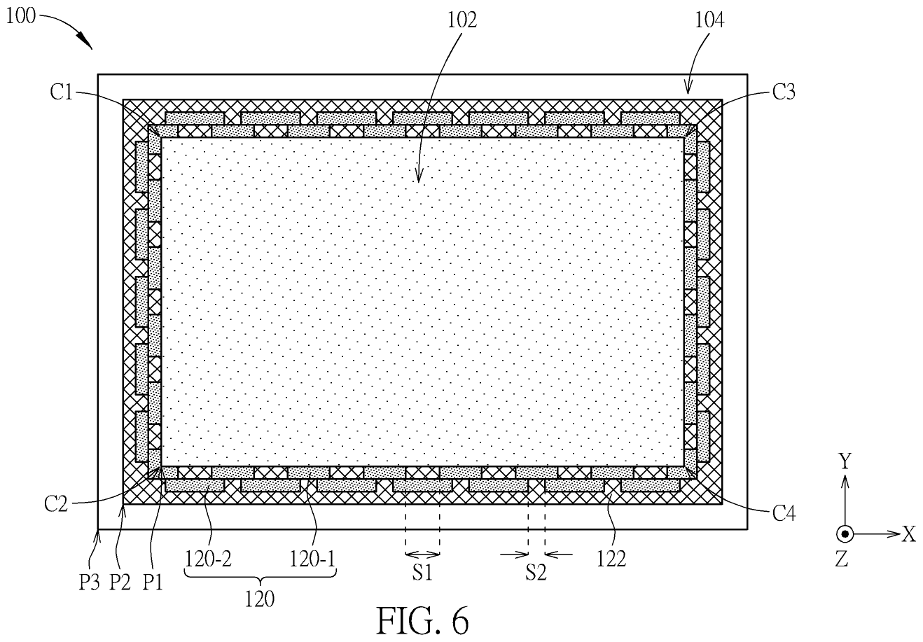

FIG. 6 is a top view schematic diagram of a flexible liquid crystal display device according to a fifth embodiment of the present disclosure. The waterproof glue 120 of this embodiment presents as a pattern of interrupted lines in a top view. Furthermore, the waterproof glue 120 of this embodiment is double layered structured, which has a plurality segments of inner waterproof glue 120-1 at the inner layer and a plurality segments of outer waterproof glue 120-2 at the outer layer, but not limited thereto. There may be a space S1 between any two adjacent segments of the inner waterproof glue 120-1, and there may be a space S2 between any two adjacent segments of the outer waterproof glue 120-2. The spaces S1 and the spaces S2 can be adjusted moderately according to the requirement. It is noted that, the inner waterproof glue 120-1 and the outer waterproof glue 120-2 may be connected with each other to surround the entire display region 102. In such design, there is a larger contact area between the water proof glue 120 and the adhesive material 122, and the adhesion is enhanced. And the waterproof glue 120 can be more closely disposed at the edge P1 of the display region 102. Furthermore, since the flexible liquid crystal display device 100 may be flexed during using, the moisture may easily be permeated from the turning positions of the peripheral region 104 (such as the corner regions C1, C2, C3, C4). Therefore, in this embodiment, at the corner regions C1, C2, C3, C4 in the peripheral region 104, the locations close to the display region 102 are all disposed with the waterproof glue 120 to strengthen the waterproof function at the turning positions.

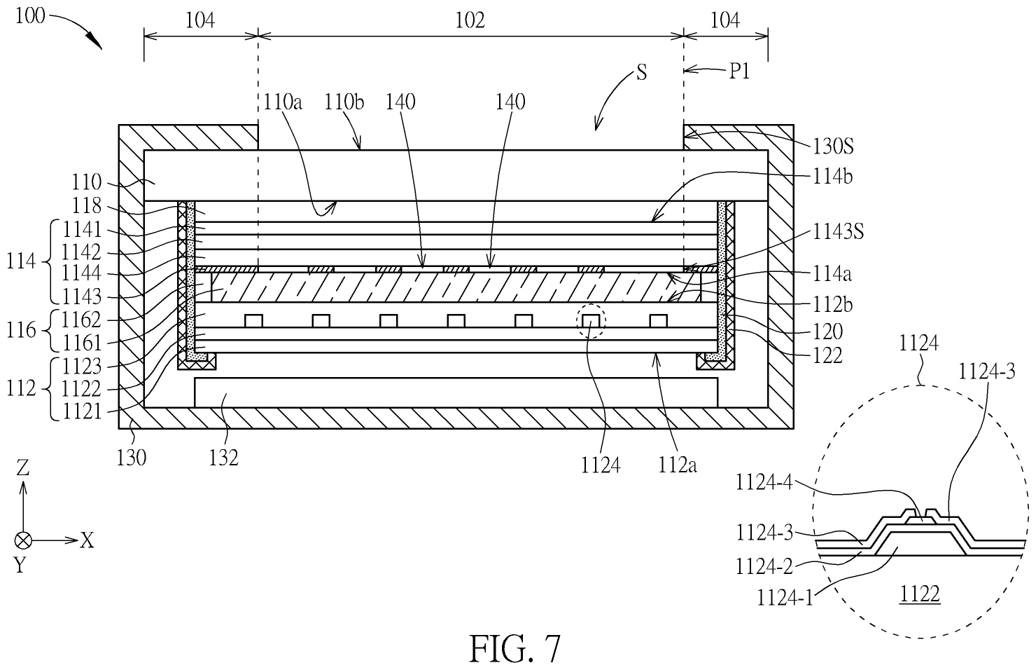

FIG. 7 is a cross-sectional view schematic diagram of a flexible liquid crystal display device according to an embodiment of the present disclosure. More components in the flexible liquid crystal display device 100 are further drawn in this embodiment, and more particular to the components in the first flexible substrate 112 and the second flexible substrate 114. Referring to FIG. 7, the first flexible substrate 112 may include a polarizer 1121, a substrate 1122, and a switch element layer 1123, wherein the polarizer 1121 and the switch element layer 1123 can be respectively disposed on the two opposite surfaces of the substrate 1122, but not limited thereto. Furthermore, there are a plurality of switch elements 1124 such as thin film transistors having a bottom gate in the switch element layer 1123. Referring to the lower right figure in FIG. 7, each switch element 1124 can include a bottom gate 1124-1 disposed on the substrate 1122, a gate dielectric layer 1124-2 disposed above the bottom gate 1124-1, a source/drain 1124-3 disposed on both sides above the bottom gate 1124-1 and a semiconductor layer 1124-4 sandwiched between the gate dielectric layer 1124-2 and the source/drain 1124-3. The second flexible substrate 114 selectively includes a polarizer 1141, a substrate 1142, a light shielding layer 1143 and a color filter 1144. The polarizer 1141 and the color filter 1144 can be respectively disposed on the two opposite surfaces of the substrate 1142. The liquid crystal layer 116 can further include liquid crystal material 1161 and a sealant 1162, wherein the sealant 1162, the first flexible substrate 112 and the second flexible substrate 114 may enclose the liquid crystal material 1161 in a space. The flexible liquid crystal display device 100 further includes an outer frame 130 and a backlight device 132. The light from the backlight device 132 cannot transmit through the regions blocked by the light shielding layer 1143, so a plurality of pixel illuminating regions 140 are defined in the display region 102 by the light shielding layer 1143.

The cover layer 110 can be exposed from an opening S of the outer frame 130, and the presented images of the display region 102 can be viewed from this opening S. The backlight device 132 is disposed between the outer frame 130 and the first flexible substrate 112 to provide the light required for presenting images. According to this embodiment, the waterproof glue 120 and the adhesive material 122 are not directly in contact with the outer frame 130 and the backlight device 132. However, the waterproof glue 120 or the adhesive material 122 can be directly in contact with the outer frame 130 or the backlight device 132 in other embodiments. In particular, a polarized light may be formed from the light produced by the backlight device 132 through the polarizer 1121 first, and the turning directions of the liquid crystal material 1161 at corresponding regions are controlled by the switch elements 1124 to rotate the polarization direction of partial of the polarized light, and the partial of the polarized light can sequentially pass through the components or layers such as the color filter 1144 and the polarizer 1141, and to present the images. It is noted that, a portion of the light shielding layer 1143 is disposed in the peripheral region 104 and disposed closely adjacent to the edge P1 of the display region 102, so an edge 1143S of the portion of the light shielding layer 1143 may be aligned with the edge P1 of the display region 102, or also be aligned with an edge 130S of the outer frame 130 simultaneously.

According to the flexible liquid crystal display device 100 disclosed by the embodiments described above, since the waterproof glue 120 may at least attach to the side 114c of the second flexible substrate 114, peeling off of the second flexible substrate 114, especially the side 114c of the second flexible substrate 114 from the surface of the cover layer 110 may be mitigated, and the reliability or lifetime of the flexible liquid crystal display device 100 may be increased.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A flexible liquid crystal display device, comprising:
a first flexible substrate;
a second flexible substrate disposed opposite to the first flexible substrate;
a liquid crystal layer disposed between the first flexible substrate and the second flexible substrate;
a cover layer having a surface facing the second flexible substrate; and
a waterproof glue adhered to the surface of the cover layer and a side of the second flexible substrate.

2. The flexible liquid crystal display device according to claim 1, wherein the second flexible substrate is surrounded by the waterproof glue.

3. The flexible liquid crystal display device according to claim 1, wherein the first flexible substrate is surrounded by the waterproof glue.

4. The flexible liquid crystal display device according to claim 1, further comprising an adhesive material adhered to the surface of the cover layer and the waterproof glue.

5. The flexible liquid crystal display device according to claim 4, wherein the waterproof glue is surrounded by the adhesive material.

6. The flexible liquid crystal display device according to claim 4, wherein the adhesive material is directly in contact with the waterproof glue.

7. The flexible liquid crystal display device according to claim 4, wherein the waterproof glue is sandwiched between the side of the second flexible substrate and the adhesive material.

8. The flexible liquid crystal display device according to claim 4, wherein the first flexible substrate comprises a first surface and a second surface, the first surface faces the liquid crystal layer, and the second surface is disposed opposite to the first surface, wherein at least one portion of the adhesive material is disposed on the second surface of the first flexible substrate.

9. The flexible liquid crystal display device according to claim 8, wherein the at least one portion of the adhesive material disposed on the second surface of the first flexible substrate has a shape of curved surface.

10. The flexible liquid crystal display device according to claim 4, wherein the first flexible substrate comprises a side, and the waterproof glue is sandwiched between the side of the first flexible substrate and the adhesive material.

11. The flexible liquid crystal display device according to claim 4, wherein at least one portion of the adhesive material adhered to the surface of the cover layer has a shape of curved surface.

12. The flexible liquid crystal display device according to claim 4, wherein the adhesive material presents as a pattern of interrupted lines in a top view.

13. The flexible liquid crystal display device according to claim 1, wherein the waterproof glue presents as a pattern of interrupted lines in a top view.

14. The flexible liquid crystal display device according to claim 13, wherein the waterproof glue has a plurality of first segments at an inner layer and a plurality of second segments at an outer layer.

15. The flexible liquid crystal display device according to claim 14, wherein the plurality of first segments have a first space between any two adjacent first segments of the plurality of first segments, and the plurality of second segments have a second space between any two adjacent second segments of the plurality of second segments.

16. The flexible liquid crystal display device according to claim 1, wherein at least one portion of the waterproof glue adhered to the surface of the cover layer has a shape of curved surface.

17. The flexible liquid crystal display device according to claim 1, wherein the first flexible substrate comprises a first surface and a second surface, the first surface faces the liquid crystal layer, and the second surface is disposed opposite to the first surface, wherein at least one portion of the waterproof glue is adhered to the second surface of the first flexible substrate.

18. The flexible liquid crystal display device according to claim 17, wherein the at least one portion of the waterproof glue adhered to the second surface of the first flexible substrate has a shape of curved surface.

19. The flexible liquid crystal display device according to claim 1, wherein a width of the first flexible substrate is greater than a width of the second flexible substrate in a horizontal direction.

20. The flexible liquid crystal display device according to claim 19, wherein the first flexible substrate comprises a first surface and a second surface, the first surface faces the liquid crystal layer, and the second surface is disposed opposite to the first surface, wherein the waterproof glue is adhered to the first surface of the first flexible substrate.
